(19) United States
(12) Patent Application Publication
(10) Pub. No.: US 2008/0086483 A1
(43) Pub. Date: Apr. 10, 2008

(54) FILE SERVICE SYSTEM IN PERSONAL AREA NETWORK

(75) Inventors: Chanik PARK, Pohang-city (KR); Woojoong LEE, Pohang-city (KR); Shine KIM, Pohang-city (KR)

Correspondence Address: ROTHWELL, FIGG, ERNST & MANBECK, P.C., 1425 K STREET, N.W., SUITE 800, WASHINGTON, DC, 20005, US

(73) Assignee: POSTECH ACADEMY-INDUSTRY FOUNDATION, Pohang-city (KR)

(21) Appl. No.: 11/869,223

(22) Filed: Oct. 9, 2007

Related U.S. Application Data
(60) Provisional application No. 60/850,286, filed on Oct. 10, 2006.

(51) Int. Cl. G06F 17/30

(52) U.S. Cl. 707/10; 707/E17.032; 707/E17.01

(57) ABSTRACT

Provided is a file service system in a personal area network (PAN), which can improve accessibility of data by defining a semantic file addressing scheme and its construction mechanism on the network, as well as extensibility of data management, such as an automatic backup and replication, by including two separated layers, i.e. a data access layer and a data replication layer. Accordingly, the file service system in PAN includes a data access layer, which is constructed by using UPnP to automatically build up a semantic file address space over all personal devices in the network and using by WebDAV for file I/Os, and a data replication layer, which is based on an object-based storage device (OSD) protocol and is in charge of an automated data backup and replication, wherein the data access layer and the data replication layer are separated.

### CROSS-REFERENCE TO RELATED PATENT APPLICATION

This application claims the benefit of U.S. Provisional Patent Application No. 60/850,286, filed on Oct. 10, 2006, in the U.S. Pat. Nos. and Trademark Office, the disclosure of which is incorporated herein in its entirety by reference.

### BACKGROUND OF THE INVENTION

1. Field of the Invention

The present invention relates to a file service system in a personal area network (PAN), and more particularly, to a file service system in PAN, which can improve accessibility of data by defining a semantic file addressing scheme and its construction mechanism on the network, as well as extensibility of data management, such as an automatic backup and replication, by including two separated layers, i.e. a data access layer and a data replication layer.

2. Description of the Related Art

Nowadays, users may carry several personal devices, such as PDAs, notebooks, MP3 players, digital cameras, and smart phones, which are each equipped with a storage space well above 2 GB. With the recent advance of flash memory and small form factor hard disk technologies, each personal device will be expected to carry up to 1 TB in 2010 [1]. A mark [ ] and a number between the mark [ ] shows a material and/or documents related to the corresponding description, and information about the material and/or documents is listed at the end of the specification.

Accessing and managing digital contents scattered on the personal portable devices are really difficult tasks because of not only the dynamic and heterogeneous characteristics of the underlying network protocols and I/O interfaces but also diversity of operating systems. Moreover, due to the explosion of personal digital contents, the data access and management are emerging as a major issue lately.

In inventors' previous works regarding PosCFS [2], [3], inventors addressed the main functionalities required for file services in ubiquitous computing and presented a new smart file service which could be adapted to the requirements with a virtualization technique which provides per-user global namespace as a semantic file address space for managing and accessing data stored on physical storage spaces detected in PAN. As a by-product of virtualization, inventors could make the system include a basic context-awareness concept in the file service. That is, it could provide a special ability, retrieving files which correspond to the current context for context-aware applications. The file service was implemented using the UPnP protocol [4] to automatically build up a virtualized space over all personal devices in a PAN and also by using WebDAV [5] for file I/O.

Storage virtualization which inventors addressed was represented by two interfaces. One was a WebDAV-based storage interface and the other was the virtual directory, which is the key concept for per-user global namespace and supporting context-awareness. It is dynamically generated by matching file metadata maintained by the file service with some conditions, such as the user's profile and context information. For more details, refer to [1], [2] and the detailed description. However, in inventors' previous implementation, the user's profile and file metadata are organized to the ontology language [6], [7], but this turns out to be inefficient on small embedded devices. Moreover, the system needs to be extended to support automatic data backup management.

Examples of conventional technologies for solving above disadvantages will now be described.

The GAIA context-aware file system [10], proposed by the System Software Research Group of the University of Illinois, was the first approach which tried to adapt a context-aware concept to a file system in Active Space, an intelligent PAN. It provides a novel concept as a well-defined middleware component and is applicable to diverse computing environments. However, it is not suitable for the wearable computing environment due to its centralized file system construction mechanism; there must be one mount server for constructing a shared space between devices, and there is a lack of representations for describing file metadata.

OmniStore [11], proposed by the University of Thessaly, not only tries to integrate portable and backend storage in a PAN, but also exhibits self-organizing behavior through spontaneous device collaboration. Moreover, the system provides transparent remote file access, automated file metadata annotation, and a simple data replication framework. Despite the innovative features, the system is limited in terms of interoperability because it is implemented with its own defined discovery and file I/O protocols rather than standard protocols.

EnsemBlue [12], proposed by the University of Michigan, provides a global namespace shared by all devices in a PAN, which is maintained by a centralized file server. It also utilizes energy efficiency and file I/O performance. These features, inherited from BlueFS [13], were also developed by the same authors. However, it only provides a static global shared space, a global file tree, among devices which belong to users of the same group, such as a family or an organization.

In the meanwhile, regarding data replication frameworks in mobile ad-hoc networks or PANs, several studies have been conducted [14], [15], [16]. There are various issues related to replica relocation, consistency management, location management, and so on. Oasis [17], developed by Intel Research, provides an asymmetric peer-to-peer data replication framework tailored to the following requirements: availability, manageability, and programmability in a PAN. Oasis addresses these requirements by employing a peer-to-peer network of weighted replicas and performing background self-tuning. OmniStore [11] also provides a simple replication framework for PANs as mentioned. It was implemented based on a simple backup policy with a base station.

### SUMMARY OF THE INVENTION

The present invention provides a file service system in a personal area network (PAN), which can improve accessibility of data by defining a semantic file addressing scheme and its construction mechanism on the network, as well as extensibility of data management, such as an automatic backup and replication, by including two separated layers, i.e. a data access layer and a data replication layer.

The present invention also provides a file service system in a network which includes a data replication layer, which is separately formed from a conventional data access layer for automatic data management based on an object-based storage device (OSD) protocol.

According to an aspect of the present invention, there is provided a file service system in a personal area network (PAN), the file service system including: a data access layer, which is constructed using a peer-to-peer structure with UPnP and WebDAV protocols; and a data replication layer, which is based on an object-based storage device (OSD) protocol and is in charge of an automated data backup and replication, wherein the data access layer and the data replication layer are separated.

The data access layer may include a virtual storage.

The virtual storage may include a semantic file address space with virtual directory trees.

The data replication layer may include: OSD controllers; OSD targets; and replication managers.

The data replication layer may include: an object data field; and an object attribute field.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a file service system in a personal area network (PAN) according to an embodiment of the present invention;

FIG. 2 is a conceptual diagram of a semantic file address;

FIG. 3 is a conceptual diagram illustrating a store and storage space according to an embodiment of the present invention;

FIG. 4 is a conceptual diagram illustrating a virtual directory according to an embodiment of the present invention;

FIG. 5 is a diagram illustrating a database and a table in a metadata repository according to an embodiment of the present invention;

FIG. 6 shows an internal structure of a data replication layer according to an embodiment of the present invention;

FIG. 7 shows how a replication unit is structured in a framework according to an embodiment of the present invention;

FIG. 8 shows replication metadata according to an embodiment of the present invention;

FIG. 9 illustrates how replica metadata is updated;

FIG. 10 is a diagram for describing in detail main steps of replica discovery according to an embodiment of the present invention;

FIG. 11 is a diagram illustrating replica consistency management according to an embodiment of the present invention;

FIG. 12 is a diagram illustrating a home node election process according to an embodiment of the present invention;

### DETAILED DESCRIPTION OF THE INVENTION

Hereinafter, the present invention will be described more fully with reference to the accompanying drawings, in which exemplary embodiments of the invention are shown. While describing the present invention, detailed descriptions about related well-known functions or configurations that may diminish the clarity of the points of the present invention are omitted. Terms used in the specification are defined considering the functions, and may differ according to a user, an intention of an operator, or customs. Accordingly, definitions of the terms should be given based on the content of the specification.

In the present invention, inventors present a concept called a per-user global name space which is supported by virtual directories. The per-user global name space provides a semantic namespace inspired by previous studies. In order to support the semantic namespace in a file service, files can be indexed by their semantic metadata and accessed by the information. SFS [18], LISFS [19], CONNECTIONS [20], and LiFS [21] address the issues of how to generate semantic information and how to index and access files with the information.

Meanwhile, Table 1 compares a system of the present invention with the existing systems in relation to some criteria, such as file service construction mechanisms, file metadata management schemes for intelligent file browsing or accessing, namespace management for shared space, automatic data replication or backup, and so on.

TABLE 1

| | GAIA | OmniStore | EnsemBlue | The present invention |
|---|---|---|---|---|
| File system construction | Centralized mount server | Distributed, P2P | Centralized server | Distributed, P2P |
| method | | | | |
| File metadata management | Keyword based | Keyword based | Not support | Keyword based |
| Automated metadata | Restricted | Support | Not support | Restricted (extracting |
| annotation | | | | from file itself) |
| Namespace management | Static and global namespace | Flat model | Static and global | Per-user global |
| for shared space | in PAN (directory-based) | | namespace | namespace-based user |
| | | | (directory based) | profile in PAN |
| Context-awareness support | Can provide files | Flat model, | Not support | Virtual directory |
| | corresponding to context | Can provide files corresponding | | corresponding to context |
| | information | to context information | | information |
| Replication framework | Not support | Backup policy with base station | Not support | Adaptive, |
| | | | | Considering device and |
| | | | | target availability of data |
| Energy efficiency and | Not considered | Not considered | Considered | Not considered |
| performance | | | | |

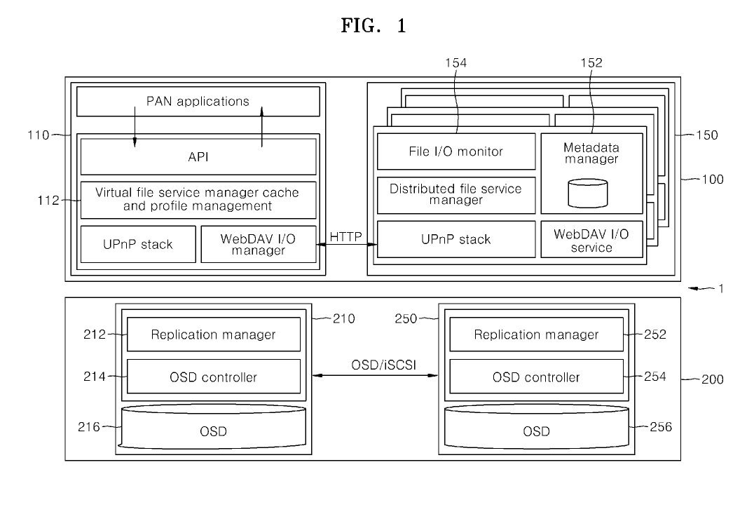

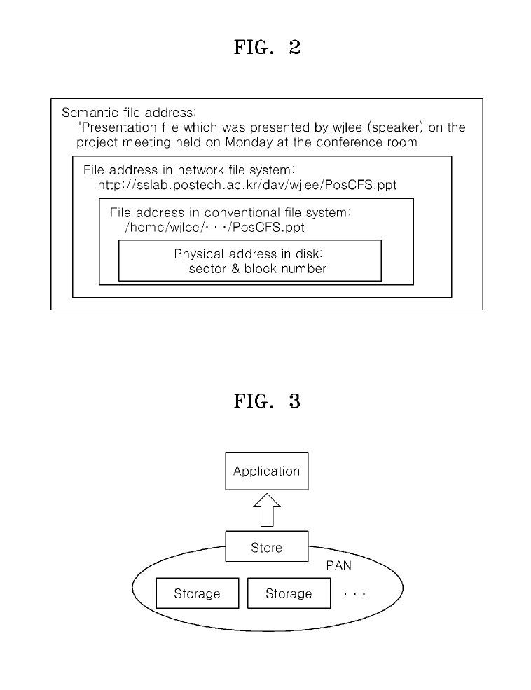

FIG. 1 is a diagram illustrating a file service system 1 in a personal area network (PAN) according to an embodiment of the present invention.

Referring to FIG. 1, the file service system 1 includes a data access layer 100 and a data replication layer 200. The data access layer 100 may be a conventional data access layer for automatic data management based on an object-based storage device (OSD) protocol, and the data replication layer 200 is separated from the data access layer 100. The data access layer 100 includes a client module 110 and a service module 120, and the data replication layer 200 includes two relocation modules 210 and 250.

The data access layer 100 is constructed using a peer-to-peer structure with UPnP and WebDAV protocols. The role of the data access layer 100 is to provide easy access to user data based on semantic metadata of files in the PAN. Easy access to user data is supported by storage virtualization, which includes the concepts of a semantic file addressing scheme with virtual directories. The data replication layer 200 is based on the OSD protocol [9] and is in charge of an automated data backup and replication considering the availability parameter of each device and the target availability pre-assigned to replication units by users. More details of these layers are disclosed in the following.

Most of the existing file systems have a namespace, such as a traditional directory structure which represents file addresses based on their own internal logic. However, the structure is rigid and implicitly assigned by users. Moreover, since the amount of user data increases rapidly, users have difficulty in managing and accessing their files. Some studies have been conducted to overcome these challenges. They define not only the traditional directory structure but also another namespace for accessing files using semantic information or the metadata on a local file system. However, they are limited in that they cannot be expanded to PANs. Thus, there is a need for a new namespace management technique with a virtualization technique which can be applied to the dynamic and heterogeneous network.

The file service systems in PAN according to the present invention use UPnP to discover and control one another in a peer-to-peer manner. The WebDAV protocol is used for file I/O in the system. This protocol is an extended version of HTTP, which defines some extended methods for supporting file I/O on a traditional network file system, such as file writing, directory and file property management and locking, as well as the basic methods defined as HTTP, GET, and POST, which are methods for file reading. By using these global standards, a platform-independent and self-constructible file service is able to be implemented.

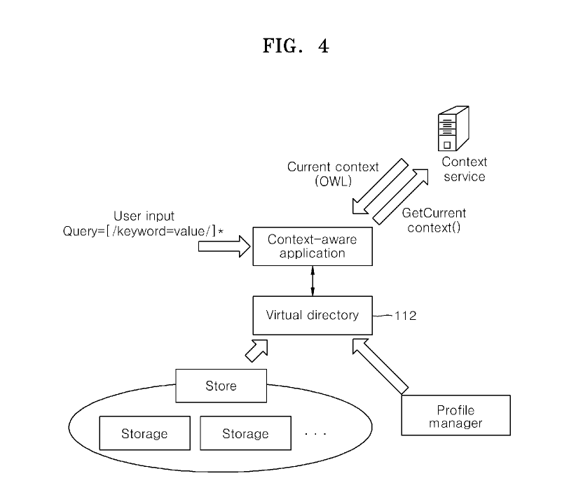

As shown in FIGS. 3 and 4, in the present invention, there are two concepts of storage space: the storage view and virtual directory view. The store interface in the figures, a connection point to virtual space in PAN, is dynamically and automatically constructed and managed by the UPnP protocol. The storage interface in the store provides an abstraction of WebDAV-based storage. The virtual directory is a basic unit of semantic file addressing in the present invention system. As shown in FIG. 4, a virtual directory 112 is dynamically constructed by matching file metadata maintained by the file service with some conditions, such as user query, profile, and context information. The details of the construction mechanism are described later.

The present invention uses a simple keyword-based query and an SQLite [8] based metadata repository to enhance the query performance and alleviate metadata management overhead. A semantic file addressing according to the present invention will be described in detail in the following.

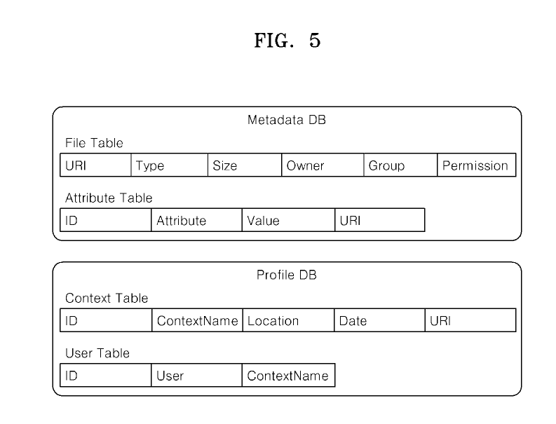

The roles of the metadata repository managed by a metadata manager 152 in FIG. 1 are to store and manage the semantic metadata of files. For that purpose, the repository stores two kinds of databases whose schema are shown in FIG. 5. One is for file metadata and the other is for user profiles. The metadata database is managed by a background process called a file I/O monitor 154 process in FIG. 1. The file I/O monitor 154 process carries out the monitoring and logging of file I/Os and then updates the metadata database with extracted information from the file tags and the underlying file system. Most file formats have their own metadata fields. For instance, in the case of an MP3 format, the file I/O monitor 154 extracts some semantic information, such as “Artist” and “Genre” from the ID3 tag of the format. The pdf or ps format has some tags for “Author,” “Title,” “Subject,” and so on. For extensibility, an attribute table is designed, whose internal representation is similar to the RDF triple structure, resulting in no limitation of the number of attribute-value pairs attached to a file resource.

A profile database stores the user profile which consists of two types: named context and unnamed context. The named context represents explicit details of the user's schedule or events. For instance, “Project Meeting,” “Room 423 in PIRL building,” and “2007-02-01” can be used as field values representing a named context in the context table. On the other hand, the unnamed context represents a situation defined by a location and a point of time. This information may be useful for maintaining the user's preference of files in a given situation. For example, the present invention can maintain information such as which music files have been played at home by a user.

The present invention defines user profile for supporting per-user global namespace. Each client component has the profile information, which consists of two parts. One is the view preference that defines view-types and virtual directory construction rules. The other part is related to profile DB configurations such as the default DB location, which means a service component node that maintains user contexts. The rules can be described with some pre-defined commands, such as “DIR(NAME|NAMING-RULE){CONDITIONS}” and “SDIR(NAME|NAMING-RULE) {CONDITIONS}”. From the sequence of “DIR” and “SDIR”, the rules are included by some specific conditions that correspond to the file metadata and context information maintained by service nodes. Some examples are given below.
a) DIR(docs) {file-class=“document”};
b) DIR(docs) {file-class=“document”}; SDIR(author=*){ };
c) DIR(music) {file-class=“music”}; SDIR(artist=*){ }; SDIR(genre=*){ };
d) DIR(current) {ctx-name=“project meeting”};
e) DIR(snapshot){ };SDIR(ctime=*){ctime≦20070505 & ctime≦20070501}

Virtual directories are dynamically created at each service node, and then merged into a file tree at a client node requesting with a query that is generated from a user input profile or current context information. How to create a virtual directory can be specified using relational algebra. A virtual directory, its sub-virtual directory, and files included in the directory can be obtained as shown in the algebra, represented by V and Fv, respectively. This process tries to match a keyword either explicitly given by the user or by a special type of user profile (view preference) to build a per-user global namespace in the PAN and file metadata which is maintained by the file and attribute tables. Due to the RDF-like structure of the attribute table, the present invention can obtain the results, V and Fv, from join operations with tables that are obtained by selection with each keyword; Vctx and FVctx can be simply obtained by selection of each keyword using the context table. The namespace, in other words, is a virtual directory tree constructed using view preference maintained by the virtual file service manager 112 of client module 110 as shown FIG. 1. It contains virtual directory construction rules for each file type, such as documents, presentations, and types of images.
V:=πᵥₐₗᵤₑ((σ_{Aattr =k} (A) [symbol] ᵤᵣᵢ σ_{A}_{_{cond}}₍₀₎ (A) [symbol] ᵤᵣᵢ . . . σ_{A}_{_{cond}}₍ₙ₋₁₎ (A)) [symbol] ᵤᵣᵢ σ_{F}_{_{cond}} (F)),
F_{V} :=πᵤᵣᵢ((σ_{A. atty=k} [symbol] _{A value=value} (A) [symbol] _{cond} σ_{A}_{_{cond}}₍₀₎ (A) [symbol] ᵤᵣᵢ . . . σ_{A}_{_{cond}}₍ₙ₋₁₎ (A)) [symbol] ᵤᵣᵢ σ_{F}_{_{cond}} (F)),
V_{crx} :=πₖ_{_{crx}} (σ_{C}_{_{cond}} ₍₀₎ [symbol] _{C}_{_{cond}} ₍₁₎ [symbol] . . . _{C}_{_{cond}}₍ₙ₋₁₎ (C)),
F_{Vetx} :=πᵤᵣᵢ (σ_{C}_{_{cond}} ₍₀₎ [symbol] _{C}_{_{cond}} ₍₁₎ [symbol] . . . _{C}_{_{cond}}₍ₙ₋₁₎ (C)),
where n:size of list,
F:File table,
A:Attribute table,
C:Context table,
F_{cond}:List of field name and value pairs in F,
A_{cond}:List of attribute-value pairs in A,
C_{cond}:List of field name and value pairs in C,
k:Keyword for virtual directory,
k_{ctx}:Context keyword for virtual directory,
V:a set of virtual directories,
V_{ctx}:a set of virtual directories corresponding to a context query,
F_{V}:a set of files in V,
F_{Vctx}:a set of files in V_{ctx}.

In the present invention, the data replication layer (or the data management layer) 200 is implemented using the OSD protocol for data management and replication and the UPnP protocol to discover each replication component. This layer is a perfectly separated module with an upper layer, the data access layer 100. It is designed for a private PAN (P-PAN), which is a private network between devices belonging to a user or a group of users. The separate design of the data access and replication layers 100 and 200 enables the extensibility and interoperability of the present invention system with other non-file service system based devices such as a backup server or a home server system in a PAN. However, for cooperation with the upper layer, the present invention applies a “home node” concept for each replication unit in the file service system; a home node contains original data and replication policies. In implementation of the present invention, every file write request from the upper layer can be delivered to the home node only, and if the home node fails, then a new home node will be elected from its replicas of the replication unit while the read requests for data can be performed with any replicated data. An in-depth description of this mechanism will be presented later.

Since the present invention uses the OSD protocol for data replication and replica management, it is possible to take advantage of the main features of an OSD-based device. An OSD-based device has the following advantageous characteristics [22]:
Objects contain both data and meta-data.
It allows fine-grained object-level security.
It allows non-mediated access to networked storage devices.
It is possible to support efficient storage management, namely, controller QoS guarantees, object placement, and so on.

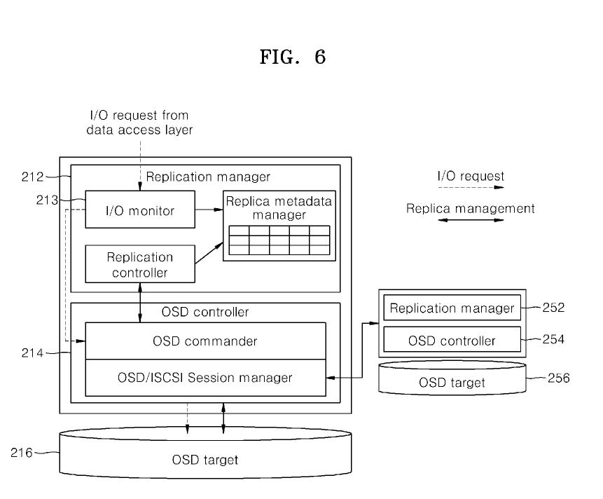

The data replication layer 200 consists of three components: OSD controllers 214 and 254, OSD targets 216 and 256, and replication managers 212 and 252. FIG. 6 shows an internal structure of the data replication layer 200. The OSD controller 214 enables a personal device to behave as an OSD initiator which can communicate with other OSD target devices. Each OSD target device detected in a PAN is recognized as a general SCSI device to the upper level data access layer 100. Since a personal device cannot always be connected to the network due to its resource-restricted environment, the data replication manager 212 must create and manage the replica nodes with replication metadata. The present invention considers the lightweight and decentralized protocol for low overhead in the resource-restricted environment of a personal device. The main functions of a replication manager 212 include: replica creation, replication placement, replica access, and management of replica metadata. The I/O monitor 213 investigates every read/write operation and maintains the read/write ratio of each object. In the data replication layer 200, creating or deleting replicas is triggered by using the read/write ratio or the pre-defined target availability of each replication unit. The replica manager maintains replica related metadata and creates and deletes replicas.

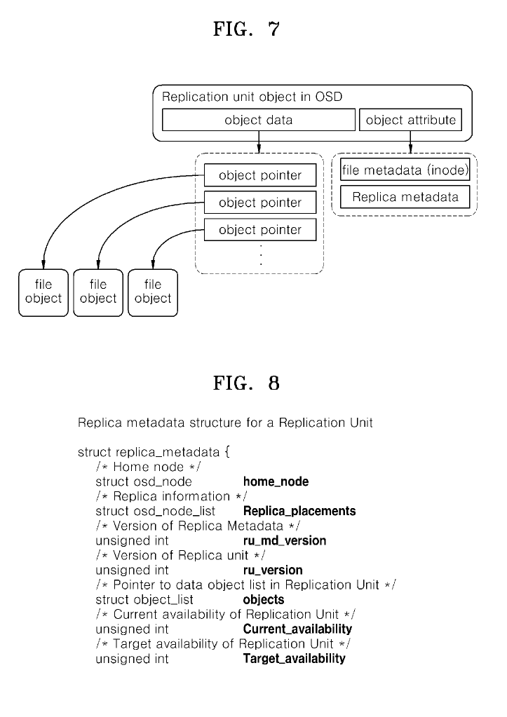

The data replication layer 200 assumes the replication unit which is a basic unit for replication. Each replication unit is an object in the object-based storage device (OSD), which is a container for real file objects, depending on the system configuration. FIG. 7 shows how a replication unit is structured in framework according to the present invention. The replication unit includes two fields: the object data field and the object attribute field. The object data field actually stores the object pointers to actual data objects to be replicated. The object attribute field contains the replica metadata on how objects are replicated. The replica metadata includes reference availability, the original owner device ID of the data, the replica node IDs, and so on. The home_node information represents the device in charge of replica creation and deletion as well as replica metadata management, whereas the replica_placements information describes the replicas of the replication unit and the failure probability of each replica. The version information for replicas themselves and replica metadata is also maintained for consistency. FIG. 8 shows an embodiment of replication metadata.

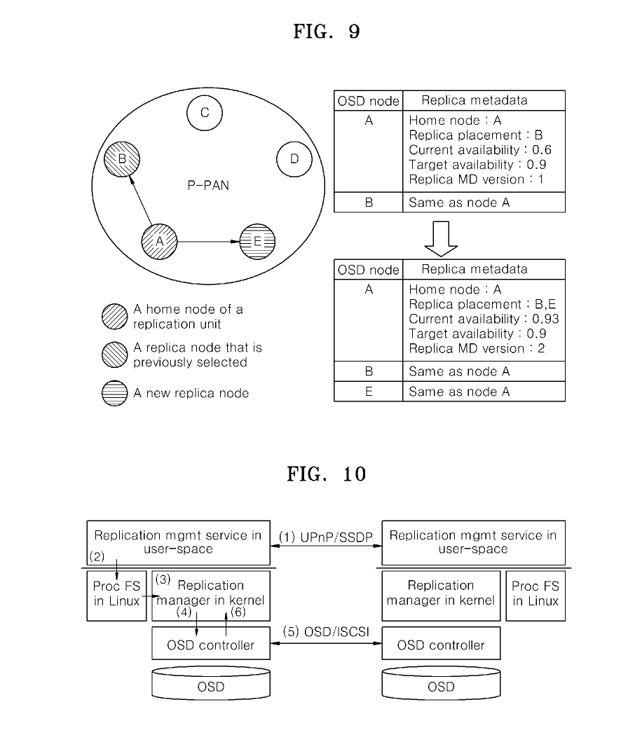

FIG. 9 illustrates how the operation of replica metadata management works. Assume that node A has the home_node (HN) of the replication unit (RU), and the replica can be found in node B. Then, the replica manager of node A tries to create a new replica in node E via the OSD protocol when it detects that the current estimated availability (0.6) of the RU is lower than the required reference availability (0.9), the target availability, specified in its replica metadata. After successfully creating a data replica in node E, the replica manager of node A re-estimates the current availability (0.93) of the RU. If the current availability is greater than or equal to the target availability, it sends the updated replica metadata of previously and newly created replicas of the RU to nodes B and E.

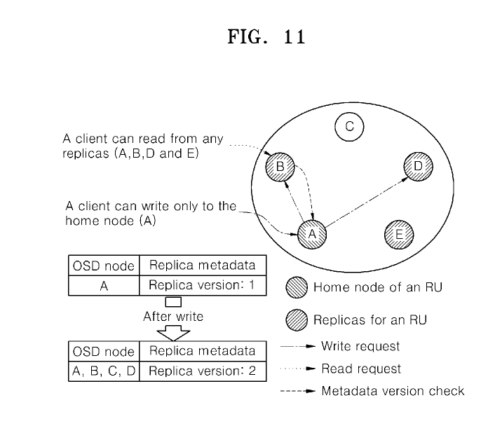

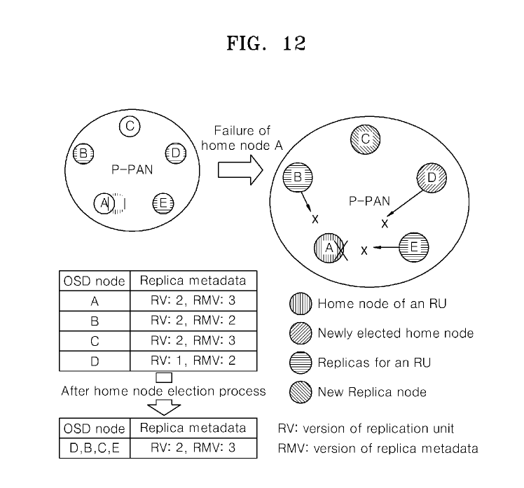

At first, the data replication layer 200 tries to discover all the accessible OSD devices. FIG. 10 describes in detail the main steps of OSD device discovery via UPnP. First, a new OSD node managed by the replication manager is discovered. Next, the replication management service on the home node shown at the left side of FIG. 10 writes the information of the newly discovered node to the proc file system in Linux, including the IP address, the failure probability of the node, and the node status. Then the replication manager obtains the information from the proc file system and updates the OSD node list which is maintained for a future replica selection. If a new replica of the RU is required, then the replication manager notifies the OSD controller to create a new replica node. The OSD controllers negotiate with each other in order to create an OSD/iSCSI session. Finally, the OSD controller reports the operation result to the replication manager. The data replication layer has to deal with the following issues for replica placement.
Data availability estimation for an RU and replica management
Consistency management
Home node election

The home node of an RU takes charge of creating and deleting replicas and updating the replica metadata. The replication manager in the home node continually estimates the failure probabilities of all the replicas under its supervision. When it finds that an RU does not satisfy the availability requirement as mentioned before, that is, the currently estimated availability of the RU is less than the desired reference availability (the target availability specified in the replica metadata of an RU), the replication manager of the home node selects a candidate node for a new replica from the OSD node list. Estimating the current availability of an RU is based on the following formula:

$$Current availability of an RU = 1 - {\prod }_{i = 1}^{n} {p}_{i}$$

where
n: the number of replicas
pᵢ: the failure probability of node i.

The present invention assumes that the failure probability of all the OSD devices is known in advance. The replication manager of the home node selects the device with the highest availability among the OSD devices as a new replica. The present invention uses a simple read-one/write-all (ROWA) method [23] for consistency management among replicas. In replication framework of the present invention, read requests for data objects are allowed from any replica, while write requests for data objects should be propagated from home nodes to all of its replicas currently available after the write requests from the upper layer. As previously mentioned, writes can be permitted only to objects maintained by home nodes.

FIG. 11 illustrates how the ROWA method works and how the replica metadata is updated. Assume that node A is the home node of a data object whose replicas are found in nodes B, D, and E. When a client sends a read request to node B, node B first retrieves the replica version information by sending a request message to home node A. Then, node B can carry out the read operation requested by the client as long as it finds that the received replica version is identical to the replica version found in its local replica metadata. Otherwise, the read request will be forwarded to the home node.

Regarding the write operation, the home node increases the replica version by one before processing a write request received from a client. After fulfilling the write request, the home node sends the updated replica metadata information to nodes B, D, and E, where the corresponding replica metadata is stored.

It is important to note that the operation of creating and deleting replicas can be performed only by the home node. Since all the nodes are weakly connected by wireless connection in a PAN, the present invention faces the situation where the HN is no longer accessible in the current configuration of a PAN. In order to ensure the correct replica operation even when the original home node is not available, the replication manager elects a new home node.

To detect the failure of a home node, every replica node has to check the status of its home node periodically. When the break-down of the original home node is detected on a replica node, they negotiate with each other for election. If a replication manager on the firstly noticed node recognizes that it has the most recently updated RU, then it becomes the new home node itself and then propagates the event for the new node election. If not, it relinquishes its right as a candidate. In that case, the secondly noticed node performs the same process. This process is repeatedly propagated to all the replica nodes in consecutive order.

Usually, there are highly stable nodes in a PAN. A home server or a desktop are typical examples for this. In such an environment, all personal data on various devices in the PAN can be automatically backed up to the most reliable node, such as a home server or a desktop.

For reference, materials and/or documents used while describing the present invention are as follows.

[1] Jim Gray, “Storage Bricks Have Arrived,” Keynote presentation at the USENIX Annual Conference on File and Storage Technologies (FAST), 2002.

[2] W. Lee, S. Kim, J. Shin, and C. Park, “PosCFS: An Advanced File Management Technique for the Wearable Computing Environment,” LNCS 4096-Proc. EUC'06, IFIP, 2006, pp. 965-975.

[3] W. Lee, S. Kim, and C. Park, “PosCFS+: A Self-Managed File Service in Personal Area Network,” ETRI Journal, vol.29, no.3, June 2007, pp.281-291.

[4] UPnP Forum, “UPnP: Universal Plug-and-Play,” http://www.upnp.org

[5] IETF, “WebDAV: Web-Based Distributed Authoring and Versioning,” RFC 2518.

[6] W3C, “RDF: Resource Description Framework,” http://www.w3c.org/RDF

[7] W3C, “OWL Web Ontology Language,” http://www.w3.org/TR/owl-features

[8] SQLite, http://www.swlite.org

[9] T10, “SCSI Object-Based Storage Device Commands (OSD),”http://www.t10.orglftp/t10/drafts/osd

[10] C. K. Hess and R. H. Campbell, “A Context-Aware Data Management System for Ubiquitous Computing Applications,” Proc. Int'l Conf. Distributed Computing Systems, 2003.

[11] A. Karypidis and S. Lalis, “OmniStore: A System for Ubiquitous Personal Storage Management,” Proc. Fourth Annual IEEE Int'l Conf Pervasive Computing and Communications (PERCOM'06), 2006.

[12] D. Peek and J. Flinn, “EnsemBlue: Integrating Distributed Storage and Consumer Electronics,” 7th Symp. Operating Systems Design and Implementation (OSDI), 2006.

[13] E. B. Nightingale and J. Flinn, “Energy-Efficiency and Storage Flexibility in the Blue File System,” 6th Symp. Operating Systems Design and Implementation (OSDI), 2004.

[14] T. Hara, “Data Replication Issues in Mobile Ad Hoc Networks,” 6th Int'l Workshop on Database and Expert Systems Applications, 2005.

[15] T. Hara and S. Madria: “Consistency Management among Replicas in Peer-to-Peer Mobile Ad Hoc Networks,” Proc. of Int'l Symp. Reliable Distributed Systems, 2005.

[16] T. Hara and S. Madria, “Location Management of Replicas Considering Data Update in Ad Hoc Networks,” Proc. 20th Int'l Conf Advanced Information Networking and Applications, 2006.

[17] M. Rodrig, A. LaMarca, “Oasis: An Architecture for Simplified Data Management and Disconnected Operation,” Personal and Ubiquitous Computing Journal, vol .9, no. 2, 2005.

[18] D. K. Gifford, P. Jouvelot, M. A. Sheldon, J. W. O'Toole, Jr., “Semantic File Systems,” 13th ACM Symp. Operating Systems Principles, 1991.

[19] Y. Padioleau, O.Ridoux, B. Sigonneau, S. Ferre, M. Ducasse, O. Bedel, and P. Cellier, “LISFS: A Logical Information System as a File System,” 28th Int'l Conf. Software Engineering, 2006.

[20] C. A. Soules and G. R. Ganger, “Connections: Using Context to Enhance File Search,” 20th ACM Symp. Operating Systems Principles, ACM Press, 2005, pp. 119-132.

[21] A. Ames, N. Bobb, S. A. Brandt, A. Hiatt, C. Maltzahn, E. L. Miller, A. Neeman, and D. Tuteja, “Richer File System Metadata Using Links and Attributes,” Proc. the 22nd IEEE/13th NASA Goddard Conf. Mass Storage Systems and Technologies, Monterey, Calif., April 2005.

[22] IBM, “Object Storage: The Future Building Block for Storage Systems,” http://dl.alphaworks.ibm.com/technologies/osdsim/osdsim2.pdf

[23] R. Budiarto, S. Noshio, and M. Tsukamoto, “Data Management Issues in Mobile and Peer-to-Peer Environments,” Data and Knowledge Engineering, vol. 41, 2002, pp.183-204.

As described above, the file service system in a PAN according to the present invention can improve extensibility of data management, such as an automatic backup and replication, and interoperability by including two separated layers, i.e. a data access layer and a data replication layer.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A file service system in a personal area network (PAN), the file service system comprising:
a data access layer, which is constructed using a peer-to-peer structure with UPnP and WebDAV protocols; and
a data replication layer, which is based on an object-based storage device (OSD) protocol and is in charge of an automated data backup and replication, wherein the data access layer and the data replication layer are separated.

2. The file service system of claim 1, wherein the data access layer comprises a virtual storage.

3. The file service system of claim 2, wherein the virtual storage comprises a semantic file addressing scheme with virtual directory tree.

4. The file service system of claim 1, wherein the data access layer uses a keyword-based query.

5. The file service system of claim 1, wherein the data access layer comprises a database for file metadata and a database for a user profile.

6. The file service system of claim 5, further comprising a file I/O monitor for managing the database for file metadata, wherein the user profile is formed of named context and unnamed context.

7. The file service system of claim 3, wherein the virtual directory is obtained using the following formula.
V:=πᵥₐₗᵤₑ((σ_{A}_{_{cond}} ₍₀₎=k (A) [symbol] ᵤᵣᵢ σ_{A}_{_{cond}}₍₀₎(A) [symbol] ᵤᵣᵢ . . . σ_{A}_{_{cond}}₍ₙ₋₁₎ (A)), [symbol] ᵤᵣᵢ σ_{F}_{_{cond}} (F)),
F_{V}:=πᵤᵣᵢ((σ_{A}_{_{ari=K}} [symbol] _{A value=value} (A) [symbol] ᵤᵣᵢ σ_{A}_{_{cond}}₍₀₎ (A) [symbol] ᵤᵣᵢ . . . σ_{A}_{_{cond}}₍ₙ₋₁₎ (A)) [symbol] ᵤᵣᵢ σ_{F}_{_{cond}} (F)),
V_{ctx}:=πₖ_{_{ctx}} (σ_{C}_{_{cond}}₍₀₎ [symbol] _{C}_{_{cond}}₍₁₎ [symbol] . . . _{C}_{cond}₍ₙ₋₁₎ (C)),
F_{V}_{_{ctx}}:=πᵤᵣᵢ(σ_{C}_{_{cond}} ₍₀₎ [symbol] _{C}_{_{cond}} ₍₁₎ [symbol] . . . _{C}_{_{cond}} ₍ₙ₋₁₎ (C)),
where n:size of list,
F:File table,
A:Attribute table,
C:Context table,
F_{cond}:List of field name and value pairs in F,
A_{cond}:List of attribute-value pairs in A,
C_{cond}:List of field name and value pairs in C,
k:Keyword for virtual directory,
k_{ctx}:Context keyword for virtual directory,
V:a set of virtual directories,
V_{ctx}:a set virtual directories corresponding to a context query,
F_{V}:a set of files in V,
F_{Vctx}:a set of files in V_{ctx}.

8. The file service system of claim 1, wherein the data replication layer comprises:
OSD controllers;
OSD targets; and
replication managers.

9. The file service system of claim 1, wherein the data replication layer comprises:
an object data field; and
an object attribute field.

10. The file service system of claim 9, wherein the object data field stores an object pointer, which points an actual data object to be replicated, and the object attribute field comprises replica metadata related to a replication method of the data object.
